(19) United States
(12) Patent Application Publication
(10) Pub. No.: US 2014/0363263 A1
(43) Pub. Date: Dec. 11, 2014

(54) SPLIT TRAILER FOR COLLAPSIBLE PORTABLE SHELTER UNIT

(71) Applicant: ELITE ALUMINUM CORPORATION, Coconut Creek, FL (US)

(72) Inventors: Yigal ZADOK, Fort Lauderdale, FL (US); Jeffrey STROHECKER, Parkland, FL (US)

(73) Assignee: ELITE ALUMINUM CORPORATION, Coconut Creek, FL (US)

(21) Appl. No.: 14/208,161

(22) Filed: Mar. 13, 2014

Related U.S. Application Data
(60) Provisional application No. 61/784,596, filed on Mar. 14, 2013.

(51) Int. Cl. B62D 63/06; B62D 63/08; B60P 1/00

(52) U.S. Cl. CPC B62D 63/062; B60P 1/00; B62D 63/08
USPC 414/507; 280/400

(57) ABSTRACT

A trailer with a split frame, for moving loads such as collapsible portable shelter Units (‘Units”), which are long, high and relatively narrow, or other loads having similar dimensions, the Units after being located between the legs of the trailer frame, when the crossbeams are removed, can be jacked up, the cross beams reinserted, and the Unit lowered to rest on the inserted crossbeams, allowing the Unit to now be carried by the trailer and transported without using cranes, forklifts or other heavy equipment.

### CROSS-REFERENCE TO RELATED APPLICATIONS

The pending utility patent application claims priority under 35 U.S.C. §119(e) to U.S. Provisional Patent Application No. 61/784,596, filed on Mar. 14, 2013 the disclosure of which is incorporated herein by reference.

### BACKGROUND OF THE INVENTION

This is an application for a Utility Patent for a trailer that is used for transporting a Collapsible Portable Shelter Unit or similarly shaped loads (hereinafter “Unit(s)”) that will make the unit accessible for locating where desired, using a trailer that is operated, does not require a crane, forklift or other mechanized equipment to load or unload the trailer, and can be hauled by a truck or other vehicle.

Emergency type shelter Units that are capable of being collapsed for transport have been available but are difficult to transport and place into use, as well as difficult to easily relocate or remove. Recent innovation has made the collapsible Units when closed more compact and concentrated in weight. The problem has been that the Units are typically desired in areas that do not have heavy lifting equipment available or are lacking power, such as when natural disasters occur. The desire to obtain a greater useable area when the Units are opened to allow them to function as temporary housing with air conditioning and lighting, has caused the Units to be heavier, as well as longer and higher in their closed state. This has made the handling of such Units difficult for work crews who often don't have the needed equipment or any special training. The large size and weight also make the hauling of the Units difficult. The typical trailer for an automobile hauling a load is the type used for boats as seen in U.S. Patent Application No. US2013/0038436 A1 dated Feb. 14, 2013. This type of trailer which requires the load to be pulled onto the trailer or set upon the trailer is limited by the ability to have heavy equipment to lift the load or in the case of a boat to use a wench type mechanism to pull the load onto the trailer. In this case, the boat is hauled onto the bed of the trailer using a wench to pull the boat into position. The use of this type of trailer is, of course, limited by the ability to pull the load onto the trailer or, in the alternative, having equipment such as forklift or crane available to lift the load and place it onto the trailer whether it be shaped to the loads outline or placed onto a flatbed trailer.

The flatbed trailers employed for transport such as that shown in U.S. Pat. No. 7,959,215B2 dated Jun. 14, 2011, when used for moving collapsible portable shelter units must utilize a crane or forklift to lift the load and most importantly when deployed in areas where mechanized equipment is limited have problem effectuating unloading, or reloading onto the trailer after use. Since a typical collapsible portable shelter unit can weigh anywhere from two thousand pounds to four thousand pounds or more, moving the Units creates a problem for deploying them in emergencies which is when the Units are most needed. The collapsible portable shelter unit as shown in US Patent Application Publication No.: US 2013/0019913A1 dated Jan. 24, 2013 to Zadok, is an example of a compact collapsible portable shelter units that can weigh close to two tons, stand over eight feet height, twenty feet long and have a width of about three feet.

The weight and large size in the height and length, with a relatively small depth make the unit hard to handle and easily tipped, if not correctly lifted. The problem was to devise a trailer that could quickly place the Unit onto the trailer, preferably without power units being needed, could quickly deploy it in a field setting or where prepared pads were not required, and could easily and quickly set the Units into the desired place; doing such work without the need to have a highly trained crew. The split trailer solves these problems. It can transport the Units simply, easily, securely, and without need of crane, forklift or other mechanized equipment.

### BRIEF SUMMARY OF INVENTION

The present invention is a split trailer having its frame composed of two legs straddling the Unit, utilizing removable crossbeams which support the load, and horizontal jacks to position the load in a centered location. The split trailer described herein is coordinated to work with the collapsible portable shelter unit of U.S. Patent Application No. 2013/0019913A1, but can work with loads lifted by suitable portable jacks, or with loads that have extendable legs that can lift the load in a vertical direction. The trailer body is constructed in a U shape with one end of each leg meeting at the head of the U where they are joined together. This allows the trailer frame to be moved into position on both sides of the Unit when dropping of the unit or picking it up. The trailer when picking up a Unit is moved to one end of the Unit in the same line as the Unit's length, centering the Unit at the opening of the U. The trailer is then moved to allow the Unit to be positioned within the U. The trailer is then left in position while the Unit is raised vertically to a height where the base portion of the Unit is higher that the level of the removable crossbeams of the trailer. The crossbeams are slide into position under the Unit and the Unit is then lowered onto the crossbeam supports. The horizontal centering jacks at the front and back of the trailer are used to position the Unit into a centered location. The Unit is then strapped to the sides of the trailer frame and the trailer can then move the Unit to the location needed. In the case of the referenced Unit the jacks for lifting and lowering the Unit are integrated in the Unit frame and a separate jack to lift the Unit is not needed. Preferably, two centering jacks are affixed to the trailer frame at the forward portions and two at the back portions to allow centering of the load to be easily accomplished. If the lifting jack is separate from the Unit, the jack must be suitable to provide stability and support for the unit weight. The strapping of the Unit to the trailer frame may be accomplished with straps fixed from designated points on the Unit frame to connections along the trailer frame.

### BRIEF DESCRIPTION OF DRAWINGS

FIG. 1 Top view of trailer.

FIG. 2 Side view of trailer.

FIG. 3 Side view of trailer with crossbeams and Unit in place.

### DETAILED DESCRIPTION OF THE INVENTION

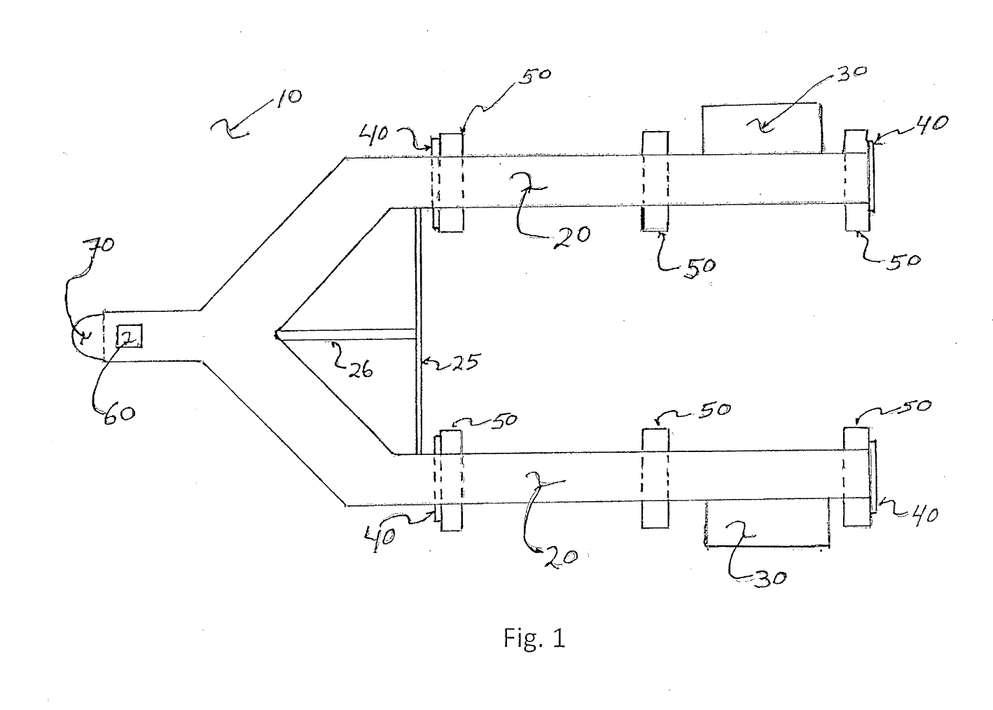

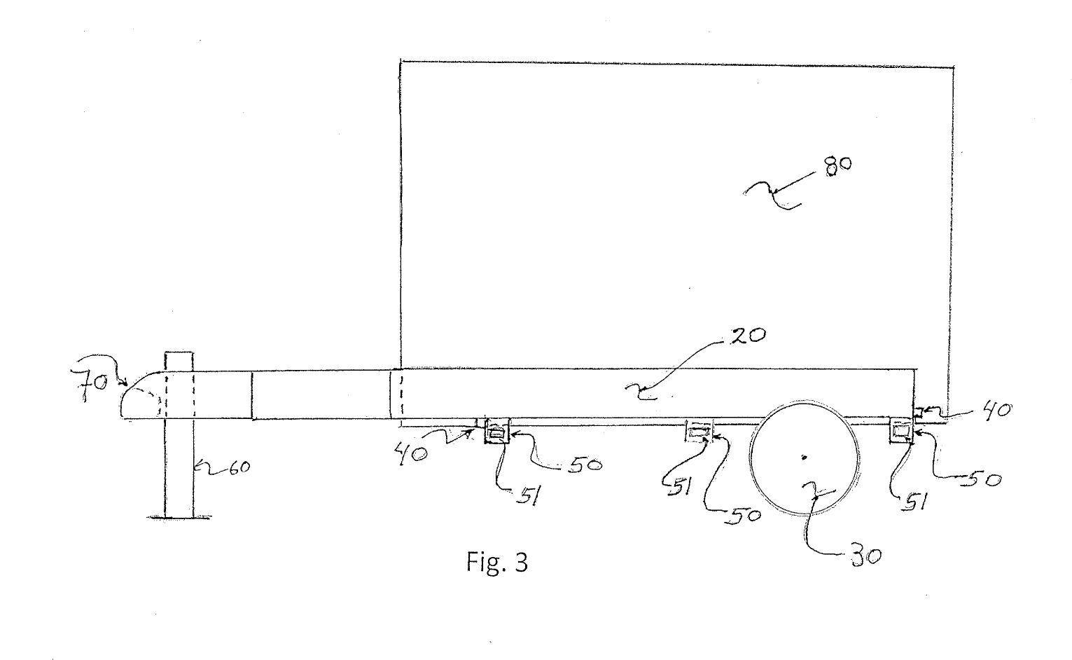

FIG. 1 shows a top view of the split trailer 10 without the crossbeams installed. The frame of the trailer is steel in a square configuration, hollow, either steel sheet being bent into a square with a welded seam or extruded as one piece. This square configuration provides high strength against bending when the trailer frame 20 is loaded. As seen in FIG. 1, the shape of the trailer is that of a U with two legs 20 where each have one end that meets to form the closed end of the U. The exact shape of the trailer frame can be adjusted to coordinate with the shape of the load being moved. At the closed end of the U there is a connection 70 that allows the trailer to attach to a typical vehicle trailer hitch. A vertical jacking mechanism 60 is located near the closed end of the closed portion of the trailer frame to allow that portion of the trailer to be supported when the trailer is not attached to a vehicle and to raise the end of the trailer to allow ease of attachment. The space between the legs of the trailer 20 is to be sufficient to allow the collapsible portable shelter Unit (the “Unit” hereafter), to be placed between the trailer legs 20. On the exterior of the trailer frame wheels 30 are affixed which are axled from the frame 20 away from the interior of the frame. This is sometimes referred to as a split axle. At the closed end of the frame support members, 25 and 26, are placed to add rigidity to the frame 20. Support member 25 can be placed not only to provide support but to limit the movement of the Unit within the frame. The Unit FIG. 3, 80, can have dimensions of twenty feet in length, nine feet in height and three to four feet in depth when standing in place, giving the base of the Unit, three feet or four foot by twenty foot cross-sectional dimension.

At preferably three locations, on the underside of each leg of the trailer frame, although a greater number can be used if required to support the load, are welded crossbeam receivers, 50, at equal distant points along it's the leg's length, with corresponding cross beam receivers 50 on the opposite side of the frame 20. The crossbeam receivers 50 are rectangular hollow steel beams through which the cross beam supports 51 are placed. See FIG. 3.

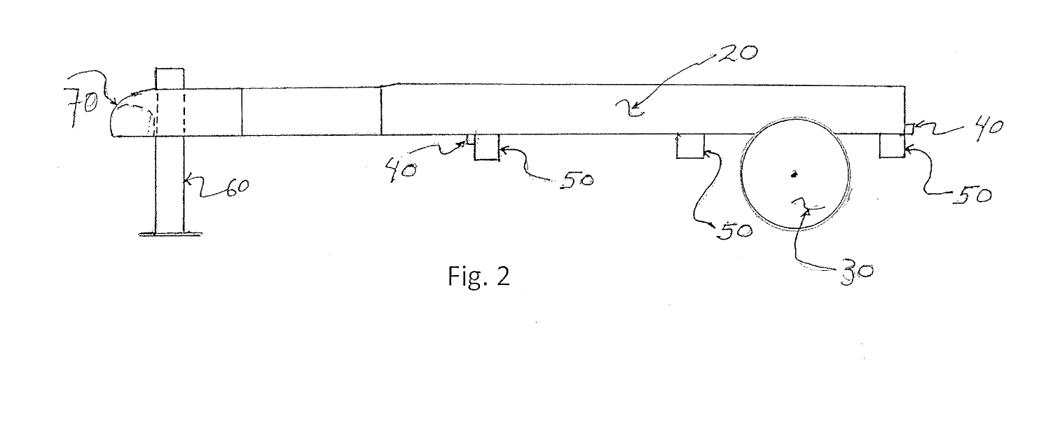

In FIG. 2 we see the trailer frame 20 from a side view. The trailer vehicle hitch connector 70 for attaching the trailer 20 to a vehicle and the vertical jack 60 to allow lifting the trailer to allow the ball connector 70 to be put in place as well as to provide support to the trailer 10 when not attached to a vehicle are shown at one end of the trailer frame. At four locations we see the horizontal centering jacks 40 which extend when cranked to position the load within the frame 20 so that it is centered and stable when being transported.

In FIG. 3 we have a side view of the trailer 10 with the crossbeams 55 in place. The cross beams are sized to slide through the cross beam receivers 50, and have each end of the crossbeam 55 seated in a crossbeam receiver 50. Preferably a pin is placed vertically through the crossbeam receiver 50 and the crossbeam 55 to lock the crossbeam in place, however, any form of locking mechanism may be used.

The employment of the trailer is implemented with the Unit in a closed position. The trailer 10 is positioned in front of the Unit 80 with the crossbeams 55 removed and slowly backed to allow the Unit 80 to be inserted between the legs 20 of the trailer frame. The Unit 80 is then jacked up on each end such that the bottom of the Unit 80 is above the elevation of the crossbeams 55 when they are in the crossbeam receivers 50. The Unit 80 as shown in U.S. Patent Application No. 2013/0019913A1 can to be jacked up on its integrated legs at each end of the Unit. This can be done with a mechanical crank mechanism.

The Unit is then standing on its jacks between the trailer legs 20, and the crossbeams 55 are inserted through the crossbeam receivers 50. The Unit jacks are then cranked up to allow the Unit to be lowered onto the cross beams. The horizontal centering jacks 40 are then cranked to position the Unit 80 into a centered position. The horizontal centering jacks 40 can be preset to the correct settings need for centering the Unit 80. The Unit may then be strapped down to the sides of the trailer for greater stability when traveling. The trailer is designed to be used primarily as a means to transport Units without the need for any additional mechanized equipment such as cranes or forklifts to place the Units or similar sized loads in a condition for travel on the trailer.

While various aspect and embodiments of the invention having been shown or discussed herein, other modifications that may be employed are within the scope of the invention.

### FIELD OF THE INVENTION

This invention relates to trailers. More particularly related to trailers for us with vehicles to transport collapsed portable shelter Units or other loads similarly dimensioned.

The invention claimed is:

1. A trailer for motor vehicles, comprising:
a rigid frame with a latching mechanism configured to attach to a motor vehicle, a plurality of leg components extending from the rigid frame, each leg component substantially in the same plane,
a plurality of wheel units each of the wheel unit affixed to a leg component,
a plurality of support bars, wherein the support bar is placed across one or more of the leg components to support the load placed on the trailer.

2. A trailer for motor vehicles, comprising:
a rigid frame that includes a latching mechanism configured to attach to a motor vehicle,
a plurality of leg components coming from the rigid frame, each leg component substantially parallel with each other and substantially in the same plane,
a plurality of wheel units, each wheel unit mounted on a leg component,
a plurality of brackets fastened to the leg components, the brackets engaging a support bar to be placed across the leg components to support a load placed on the trailer.

3. A trailer for motor vehicles, comprising:
a U-shaped frame,
a latching mechanism at the top of the U-shaped frame configured to attach the U-shaped frame to a motor vehicle, the U-shaped frame having a left and right leg component, each substantially parallel to each other and substantially in the same place,
a wheel unit affixed to the left leg component,
a wheel unit affixed to the right leg component,
a support bar placed across the left and right leg components to support a load placed on the trailer.

4. The trailer of claim 1,
wherein a plurality of brackets are placed within the leg components for placement of support bars.

5. The trailer of claim 1,
wherein the leg component supports a storage container.

6. The trailer of claim 1,
wherein the leg component contains a plurality of ratchets to move a load placed on the trailer to a desired location.

7. The trailer of claim 1,
wherein a plurality of brackets are affixed to the leg components for placement of support bars.

8. The trailer of claim 2,
wherein the brackets are placed within the leg component.

9. The trailer of claim 2,
wherein the leg component supports a storage container.

10. The trailer of claim 2,
wherein the leg component contains a plurality of ratchets to move a load placed on the trailer to a desired location.

11. The trailer of claim 3,
wherein the leg component supports a storage container.

12. The trailer of claim 3,
wherein the leg component contains a plurality of ratchets to move a load placed on the trailer to a desired location.

13. The trailer of claim 3,
wherein in a plurality of brackets are affixed to the leg components for placement of a support bar.

14. The trailer of claim 3,
wherein a plurality of brackets are placed within the leg components for placement of a support bar.
